(19) United States
(12) Patent Application Publication
(10) Pub. No.: US 2021/0373359 A1
(43) Pub. Date: Dec. 2, 2021

(54) Eyeglasses Having Sideshields

(71) Applicant: Po-Ju Tsai, Tainan City (TW)

(72) Inventor: Po-Ju Tsai, Tainan City (TW)

(21) Appl. No.: 16/888,976

(22) Filed: Jun. 1, 2020

(51) Int. Cl. G02C 11/00

(52) U.S. Cl. CPC G02C 11/12

(57) ABSTRACT

A pair of eyeglasses includes a body, two sideshields, and two clamps. The body includes a frame and two temples. A front end of each temple is pivotably connected to the frame and is received in a receiving groove of a respective sideshield. Each receiving groove includes upper and lower hooks for coupling with upper and lower sides of the front end of a respective temple. Each receiving groove further includes a coupling hole. Each clamp includes an extension disposed on an outer side of the respective sideshield, a block on a front end of the extension, and a clamping portion on a rear end of the extension. Each block is inserted from the outer side of the respective sideshield into a respective coupling hole. The clamping portion has a coupling groove and a retaining edge extending into the coupling groove. Each retaining edge couples with the respective temple.

### BACKGROUND OF THE INVENTION

The present invention relates to eyeglasses having sideshields and, more particularly, to eyeglasses having sideshields with enhanced assembly quality and detachment convenience.

A pair of eyeglasses generally includes a frame, one or two lens, and two temples. Sideshields can be disposed on front ends of the two temples to provide enhanced safety. The sideshields can shield the sides of the eyes of the user to enhance working safety.

A conventional assembling approach for the sideshields and the temples includes providing assembling holes in corresponding locations of the sideshields and the temples and extending screws through the assembling holes. However, the assembling holes and the screws are exposed after assembly, providing a poor appearance quality. Furthermore, when the sideshields are not required, a tool has to be used to remove the screws before detaching the sideshields, which is inconvenient to detachment.

U.S. Pat. No. 6,007,196 discloses a retainer for eyeglass frames having sideshields. A longitudinally extending channel is formed in each sideshield and is adapted to closely receive a respective temple. Each sideshield includes a clip hole. The retainer is rigid and can be made of stainless steel or die cast alloy. The retainer includes a clamp, an arm, and a hook. The clamp includes a groove for receiving a respective temple. The clamp further includes a threaded bore. After each sideshield is disposed on a respective temple, the hook of the retainer is inserted into the clip hole of the sideshield. The groove of the clamp fits around the respective temple. A tool is used to extend a screw from an inner side of the respective temple to couple with the threaded bore of the clamp and the temple. Thus, the threaded bore and the screw will not be seen from the front side of the pair of eyeglasses, providing a better appearance quality.

However, the above assembling approach still requires a tool to tighten the screw for assembly purposes, which is inconvenient to assembly. Furthermore, the tool has to be used for removing the sideshields when not in use, leading to inconvenience to detachment.

### BRIEF SUMMARY OF THE INVENTION

An objective of the present invention is to provide a pair of eyeglasses having sideshields with enhanced assembly quality and detachment convenience.

A pair of eyeglasses according to the present invention includes a body, two sideshields, and two clamps. The body includes a frame and two temples. Each of the two temples includes a front end having a pivotal portion pivotably connected to the frame. Each of the two sideshields includes a receiving groove. The front end of each of the two temples is received in the receiving groove of a respective one of the two sideshields. Each receiving groove includes an upper hook on an upper side thereof and a lower hook on a lower side thereof. The upper hook of each receiving groove is configured to couple with an upper side of the front end of a respective one of the two temples. The lower hook of each receiving groove is configured to couple with a lower side of the front end of the respective one of the two temples. Each receiving groove further includes an outer sidewall facing an outer side of the respective one of the two temples. The outer sidewall has a coupling hole. Each of the two clamps is coupled with the respective one of the two temples, is made of a flexible material, and includes an extension, a block on a front end of the extension, and a clamping portion on a rear end of the extension. The extension of each of the two clamps is disposed on an outer side of the respective one of the two sideshields. The block of each of the two clamps is configured to be inserted from the outer side of the respective one of the two sideshields into the coupling hole of the respective one of the two sideshields. The clamping portion of each of the two clamps includes two sidewalls on inner and outer sides thereof and a top wall interconnected between upper ends of the two sidewalls. A coupling groove is defined between the two sidewalls and has an opening at a lower end of the respective one of the two clamps. At least one of the two sidewalls includes a retaining edge extending into the coupling groove. Each retaining edge is configured to couple with the respective one of the two temples.

In an example, each retaining edge includes a lower end having an inclined guiding face.

In an example, each of the two temples includes a rear end having a width smaller than a width of the front end of the temple. A spacing between the upper hook and the lower hook of each of the two sideshields is larger than the width of the rear end of the respective one of the two temples, is smaller than the width of the front end of the respective one of the two temples, and is smaller than a width of the pivotal portion of the respective one of the two temples.

In an example, each of the two sideshields includes a front end having a front stop located in front of the frame. Each front stop is configured to abut the frame when the respective one of the two sideshields moves rearwards.

In assembly of the pair of eyeglasses according to the present invention, each of the two temples is folded first, and the receiving groove of each of the two sideshields is coupled with the rear end of a respective one of the two temples. Then, each of the two sideshields is moved forwards along the respective one of the two temples, and the upper and lower hooks are coupled with the upper and lower edges of the front end of the respective one of the two temples. When each of the two temples is unfolded, the front stops of the two sideshields are located in front of the frame. Furthermore, each pivotal portion abuts against the upper and lower hooks of the respective one of the two sideshields to prevent the respective one of the two sideshields from falling forwards as well as preventing the respective one of the two sideshields from falling while the respective one of the two temples is unfolded.

In assembly of the two clamps according to the present invention, the inclined guiding face of the retaining edge of the clamping portion of each of the two clamps abuts against the respective one of the two temples due to flexibility of the clamping portion, and the opening of the coupling groove flexibly expands to permit the respective one of the two temples to be inserted into the coupling groove. After coupling, each clamping portion flexibly returns to retain the respective one of the two temples by the respective retaining edge. Furthermore, inner surfaces of the coupling groove are in proper frictional contact with the outer surfaces of the respective one of the two temples. Furthermore, the extension portion can flexibly bend to move the block into the coupling hole of the respective one of the two sideshields, and the returning flexibility of the extension portion assures coupling positioning between the block and the coupling hole. Thus, the two clamps provide more stable coupling between the two sideshields and the two temples. Furthermore, assembly of the two sideshields and the two clamps of the pair of eyeglasses according to the present invention can be achieved without using any tool, providing enhanced assembling convenience.

The present invention will become clearer in light of the following detailed description of illustrative embodiments of this invention described in connection with the drawings.

### DESCRIPTION OF THE DRAWINGS

FIG. 1 is a partial, perspective view of a pair of eyeglasses having two sideshields of an embodiment according to the present invention.

FIG. 2 is a partial, perspective view of the pair of eyeglasses of FIG. 1, illustrating assembly of a sideshield and a body of the pair of eyeglasses.

FIG. 3 is a partial, perspective view of the pair of eyeglasses of FIG. 2 after assembly.

FIG. 4 is a perspective view of a pair of eyeglasses with two sideshields according to the present invention after assembly.

FIG. 5 is a cross sectional view taken along section line A-A of FIG. 4.

### DETAILED DESCRIPTION OF THE INVENTION

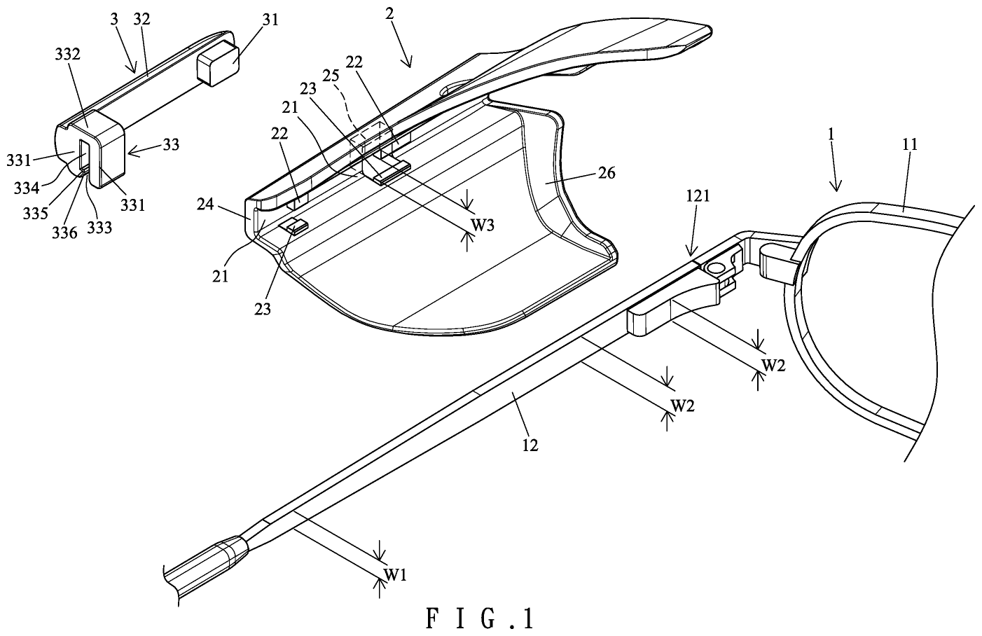

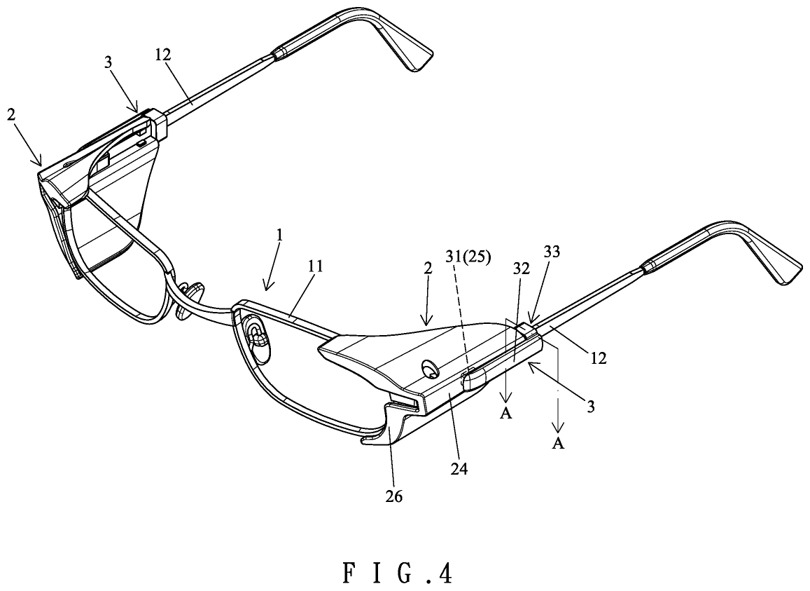

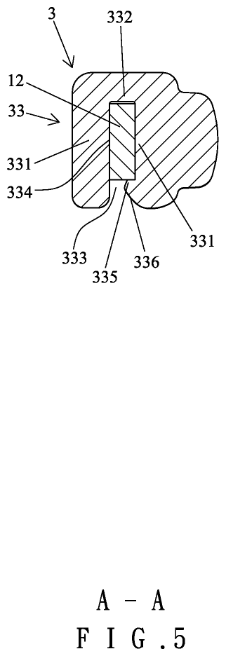

With reference to FIGS. 1-5, a pair of eyeglasses according to the present invention comprises a body 1, two sideshields 2, and two clamps 3. FIGS. 1-3 only show a portion of the body 1, one of the two sideshields 2, and one of the two clamps 3. The other side of the body 1, another of the two sideshields 2, and another of the two clamps 3 are symmetrically disposed. The body 1 includes a frame 11 and two temples 12 which are symmetrically disposed. Each of the two temples 12 includes a front end having a pivotal portion 121 pivotably connected to the frame 11. Each of the two temples 12 includes a rear end having a width W1 smaller than a width W2 of the front end and the pivotal portion 121.

The two sideshields 2 are symmetrically disposed. Each of the two sideshields 2 includes a receiving groove 21 extending in a direction corresponding to a longitudinal direction of a respective one of the two temples 12. The front end of each of the two temples 12 is received in the receiving groove 21 of a respective one of the two sideshields 2. Each receiving groove 21 includes an upper hook 22 on an upper side thereof and a lower hook 23 on a lower side thereof. The upper hook 22 of each receiving groove 21 is configured to couple with an upper side of the front end of the respective one of the two temples 12. The lower hook 23 of each receiving groove 21 is configured to couple with a lower side of the front end of the respective one of the two temples 12. A spacing W3 between the upper hook 22 and the lower hook 23 is larger than the width W1 of the rear end of the respective one of the two temples 12 and is smaller than the width W2 of the front end and the pivotal portion 121 of the respective one of the two temples 12. Each receiving groove 21 further includes an outer sidewall 24 facing an outer side of the respective one of the two temples 12. The outer sidewall 24 has a coupling hole 25. Each of the two sideshields 2 includes a front end having a front stop 26 located in front of the frame 11. Each front stop 26 is configured to abut the frame 11 when the respective one of the two sideshields 2 moves rearwards.

The two clamps 3 are symmetrically disposed. Each of the two clamps 3 is coupled with the respective one of the two temples 12, is made of a flexible material, and includes an extension 32, a block 31 on a front end of the extension 32, and a clamping portion 33 on a rear end of the extension 32. The extension 32 of each of the two clamps 3 is disposed on an outer side of the respective one of the two sideshields 2. The block 31 of each of the two clamps 3 is configured to be inserted from the outer side of the respective one of the two sideshields 2 into the coupling hole 25 of the respective one of the two sideshields 2. The clamping portion 33 of each of the two clamps 3 includes two sidewalls 331 on inner and outer sides thereof and a top wall 332 interconnected between upper ends of the two sidewalls 331. A coupling groove 334 is defined between the two sidewalls 331 and has an opening 33 at a lower end of the respective one of the two clamps 3. Each coupling groove 334 has a size corresponding to a size of the respective one of the two temples 12. At least one of the two sidewalls 331 includes a retaining edge 335 extending into the coupling groove 334. Each retaining edge 335 is configured to couple with the respective one of the two temples 12. Each retaining edge 335 includes a lower end having an inclined guiding face 336.

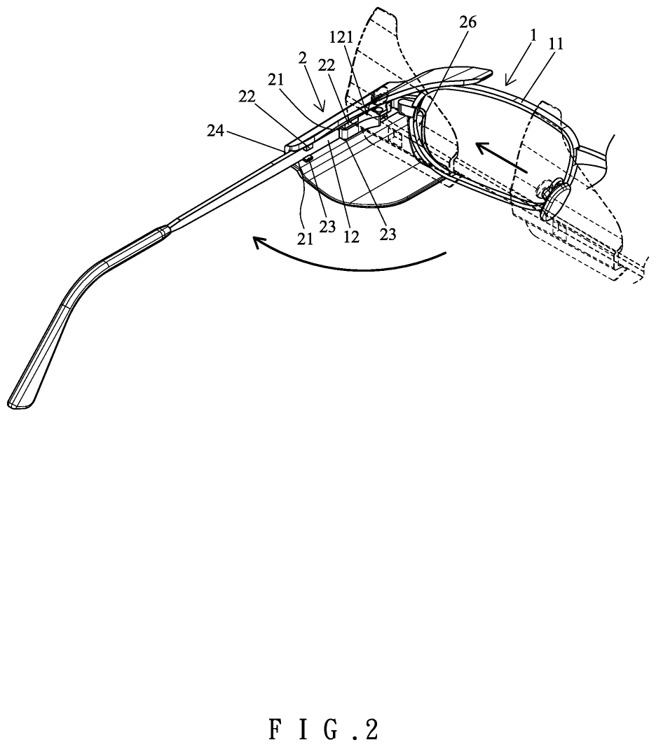

With reference to FIG. 2, in assembly of the pair of eyeglasses according to the present invention, each of the two temples 12 is folded first, and the receiving groove 21 of each of the two sideshields 2 is coupled with the rear end of a respective one of the two temples 12. Then, each of the two sideshields 2 is moved forwards along the respective one of the two temples 12, and the upper and lower hooks 22 and 23 are coupled with the upper and lower edges of the front end of the respective one of the two temples 12. When each of the two temples 12 is unfolded, the front stops 26 of the two sideshields 2 are located in front of the frame 11. Furthermore, each pivotal portion 121 abuts against the upper and lower hooks 22 and 23 of the respective one of the two sideshields 2 to prevent the respective one of the two sideshields 2 from falling forwards as well as preventing the respective one of the two sideshields 2 from falling while the respective one of the two temples 12 is unfolded.

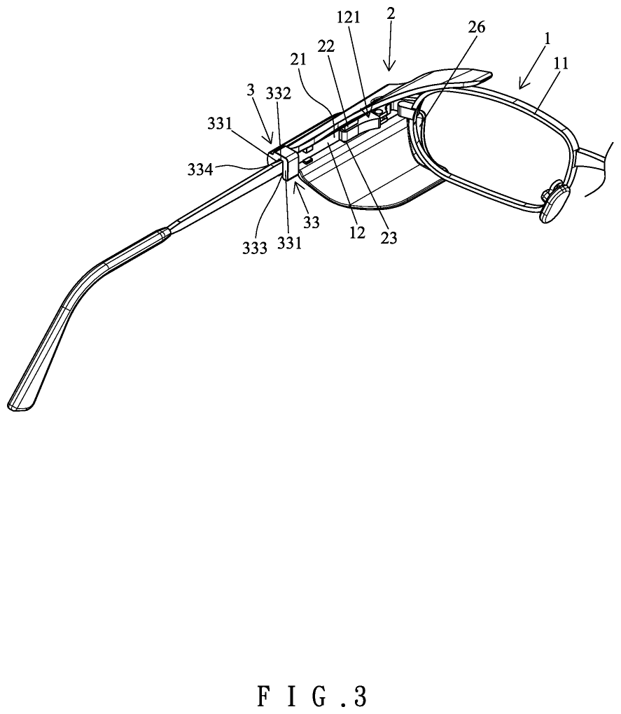

With reference to FIGS. 3-5, in assembly of the two clamps 3 according to the present invention, the inclined guiding face 336 of the retaining edge 335 of the clamping portion 33 of each of the two clamps 3 abuts against the respective one of the two temples 12 due to flexibility of the clamping portion 33, and the opening 333 of the coupling groove 334 flexibly expands to permit the respective one of the two temples 12 to be inserted into the coupling groove 334. After coupling, each clamping portion 33 flexibly returns to retain the respective one of the two temples 12 by the respective retaining edge 335. Furthermore, inner surfaces of the coupling groove 334 are in proper frictional contact with the outer surfaces of the respective one of the two temples 12. Furthermore, the extension portion 32 can flexibly bend to move the block 31 into the coupling hole 25 of the respective one of the two sideshields 2, and the returning flexibility of the extension portion 32 assures coupling positioning between the block 31 and the coupling hole 25. Thus, the two clamps 3 provide more stable coupling between the two sideshields 2 and the two temples 12. Furthermore, assembly of the two sideshields 2 and the two clamps 3 of the pair of eyeglasses according to the present invention can be achieved without using any tool, providing enhanced assembling convenience.

The two sideshields 2, when not required, can be easily detached without using any tool. Specifically, the block 31 of each of the two clamps 3 can be disengaged from the associated coupling hole 25 by using the flexibility of the two clamps 3. The coupling groove 334 of each of the two clamps 3 can be disengaged from the respective one of the two temples 12 to rapidly detach the two clamps 3. The two sideshields 2 can be removed after two temples 12 are folded. The operation is simple and easy.

Although specific embodiments have been illustrated and described, numerous modifications and variations are still possible without departing from the scope of the invention. The scope of the invention is limited by the accompanying claims.

1. A pair of eyeglasses comprising:
a body including a frame and two temples, wherein each of the two temples includes a front end having a pivotal portion pivotably connected to the frame;
two sideshields, wherein each of the two sideshields includes a receiving groove, wherein the front end of each of the two temples is received in the receiving groove of a respective one of the two sideshields, wherein each receiving groove includes an upper hook on an upper side thereof and a lower hook on a lower side thereof, wherein the upper hook of each receiving groove is configured to couple with an upper side of the front end of a respective one of the two temples, wherein the lower hook of each receiving groove is configured to couple with a lower side of the front end of the respective one of the two temples, wherein each receiving groove further includes an outer sidewall facing an outer side of the respective one of the two temples, and wherein the outer sidewall has a coupling hole; and
two clamps, wherein each of the two clamps is coupled with the respective one of the two temples, is made of a flexible material, and includes an extension, a block on a front end of the extension, and a clamping portion on a rear end of the extension, wherein the extension of each of the two clamps is disposed on an outer side of the respective one of the two sideshields, wherein the block of each of the two clamps is configured to be inserted from the outer side of the respective one of the two sideshields into the coupling hole of the respective one of the two sideshields, wherein the clamping portion of each of the two clamps includes two sidewalls on inner and outer sides thereof and a top wall interconnected between upper ends of the two sidewalls, wherein a coupling groove is defined between the two sidewalls and has an opening at a lower end of the respective one of the two clamps, wherein at least one of the two sidewalls includes a retaining edge extending into the coupling groove, and wherein each retaining edge is configured to couple with the respective one of the two temples.

2. The pair of eyeglasses as claimed in claim 1, wherein the two clamps 3 are made of plastic.

3. The pair of eyeglasses as claimed in claim 1, wherein each coupling groove has a size corresponding to a size of the respective one of the two temples.

4. The pair of eyeglasses as claimed in claim 1, wherein each retaining edge includes a lower end having an inclined guiding face.

5. The pair of eyeglasses as claimed in claim 1, wherein each of the two temples includes a rear end having a width smaller than a width of the front end of the temple, and wherein a spacing between the upper hook and the lower hook of each of the two sideshields is larger than the width of the rear end of the respective one of the two temples, is smaller than the width of the front end of the respective one of the two temples, and is smaller than a width of the pivotal portion of the respective one of the two temples.

6. The pair of eyeglasses as claimed in claim 1, wherein each of the two sideshields includes a front end having a front stop located in front of the frame, and wherein each front stop is configured to abut the frame when the respective one of the two sideshields moves rearwards.
